(19) United States
(12) Patent Application Publication
(10) Pub. No.: US 2018/0139832 A1
(43) Pub. Date: May 17, 2018

(54) WATER-COOLED PLASMA TORCH

(71) Applicant: Won-Gyu HWANG, Ulsan (KR)

(72) Inventor: Won-Gyu HWANG, Ulsan (KR)

(21) Appl. No.: 15/576,677

(22) PCT Filed: Jul. 3, 2015
(86) PCT No.: PCT/KR2015/006865

§ 371 Date: Nov. 22, 2017

(30) Foreign Application Priority Data
Jun. 16, 2015 (KR) 10-2015-0084951

(51) Int. Cl. H05H 1/28

(52) U.S. Cl. CPC H05H 1/28

(57) ABSTRACT

Disclosed is a water-cooled plasma torch. The water-cooled plasma torch of thed present invention includes a first body, a second body, an electrode, a cooling tube, an insulator, a third body, a pilot terminal, a nozzle, an inner cap, and an outer cap. The water-cooled plasma torch can increase the speed of a high-temperature plasma flame using a simple structure, can increase the lifespan of a nozzle and an electrode in contribution to improved cooling efficiency, and can apply high voltage. The water-cooled plasma torch also can increase the lifespan of a nozzle by minimizing damage to the nozzle due to a plasma flame.

### CROSS-REFERENCE TO RELATED APPLICATION

This Application is a Section 371 National Stage Application of International Application No. PCT/KR2015/006865, filed Jul. 3, 2015, the contents of which is hereby incorporated by reference in its entirety.

### TECHNICAL FIELD

The present invention relates to a water-cooled plasma torch and, more particularly, to a water-cooled plasma torch that can increase the speed of a high-temperature plasma flame using a simple structure, can increase the lifespan of a nozzle and an electrode owing to improved cooling efficiency, and can apply high voltage owing to improved cooling efficiency.

### BACKGROUND ART

Plasma cutting using a plasma torch has been disclosed in Japanese Patent Registration NO. Hei. 3-27309. Describing briefly the configuration of a plasma torch, an electrode is disposed at the center of a plasma torch and a detachable nozzle having an orifice for spouting a plasma arc at the center is disposed opposite to the electrode.

The nozzle is fixed by coupling a cap to the plasma torch and a passage for cooling water is formed between the outer side of the nozzle and the inner side of the cap.

Further, channels (supply channel and discharge channel) for cooling the electrode and the nozzle are formed in the plasma torch, and the supply channels and discharge channels are connected to the passage formed between the nozzle and the cap.

In this configuration, cooling water supplied to the plasma torch cools the electrode by corning in contact with the rear side of the electrode, then flows into the passage formed between the cap and the nozzle, cools the nozzle while flowing through the passage, and is then discharged out of the plasma torch.

Accordingly, the electrode and the nozzle are cooled by the cooling water, thus being prevented from overheating due to the heat by a plasma arc.

In the plasma torch having this configuration, a plasma arc generated by electrical conduction between the electrode and a base material to be cut is cooled and compressed while passing through the orifice, whereby it is possible to cut the base material without a molten base material.

Plasma cutting has a high cutting-speed, but has a problem that the cutting width is large in comparison to gas cutting.

Accordingly, there are methods of compressing the plasma arc thinly to decrease the cutting width in plasma cutting.

In particular, high current density is required to achieve high cutting quality, so it is further required to sufficiently compress the plasma arc.

It is required to effectively cool the nozzle, particularly around the orifice for spouting the plasma arc, in order to compress the plasma arc. However, when a cooling water passage is formed between the outer side of a nozzle and the inner side of a cap, as described in the patent document, the passage is formed close to the orifice, but the cooling water supplied from the plasma torch circulates around body of the plasma torch (the shortest distance from the supply channel to the discharge channel), so the flow of the cooling water stagnates at the end of the nozzle (around the orifice) and cooling is not sufficiently performed. Accordingly, the lifespan of the nozzle is reduced, so a worker has to frequently replace the nozzle.

### DISCLOSURE

### Technical Problem

Therefore, the present invention has been made in an effort to solve the problems and an object of the present invention is to provide a water-cooled plasma torch that can increase the speed of a high-temperature plasma flame using a simple structure, can increase the lifespan of a nozzle and an electrode owing to improved cooling efficiency, and can apply high voltage owing to improved cooling efficiency.

Another object of the present invention is to provide a water-cooled plasma torch that can increase the lifespan of a nozzle by minimizing damage to the nozzle due to a plasma flame.

### Technical Solution

In order to achieve the objects of the present invention, according to an embodiment of the present invention, there is provided a water-cooled plasma torch that includes: a first body including a body part having intake channels for gas and air, and intake and discharge channels for cooling water therein, a first diameter part protruding from the cooling water intake channel at a center of the body part, and a second diameter part protruding from the body part at a predetermined distance from the first diameter part; a second body coupled to a first end of the first body to form a first gas channel connected to the gas intake channel outside the first diameter part and the second diameter part; an electrode coupled to an end of the first diameter part; a cooling water tube inserted in a center of the first body to supply cooing water to the electrode; an insulator inserted in an end of the second body, having a first cooling water channel therein, and having a first air channel spaced a predetermined distance from the first cooling water channel; a third body coupled to an end of the insulator and having a second cooling water channel therein connected to the first cooling water channel; a pilot terminal being in contact with a predetermined portion of the third body through the first body, the second body, and the insulator; a nozzle having a center of a portion inserted in an end of the third body, having an inner side thread-fastened to a first threaded-portion formed on an outer side of the third body, and having a third cooling water channel connected to the second cooling water channel; an inner cap thread-fastened to a second threaded-portion formed on an outer side of the insulator such that the nozzle is inserted therein, and having a second air channel connected to the first air channel between an inner side thereof and an outer side of the nozzle; and an outer cap fitted on an outer side of the inner cap.

A connection pipe assembly may be coupled to a second end of the first body, and the connection pipe assembly may include: a first pipe coupled to a second end of the first body and having a cooling water supply channel therein connected to the cooling water intake channel; a second pipe coupled to the first pipe such that a main gas channel connected to the gas intake channel is formed outside the first pipe; an insulating pipe fitted on an outer side of the second pipe; and a connection pipe coupled to an end of the first pipe, having a central hole formed though a center thereof and connected to the cooling water supply channel, and having a gas supply pipe connected to the main gas channel at a predetermined position close to an edge thereof.

A welding cable may be coupled to an end of the connection pipe assembly, and the welding cable may include: a copper wire; a braided hose disposed around an outer side of the copper wire with a predetermined gap therebetween to form a cooling water supply passage; a copper tape attached to an outer side of the braided hose; an outer cover hose disposed on an outer side of the copper tape; a pair of couplers partially inserted in both ends of the braided hose with ends coupled to both ends of the copper wire, respectively; and sockets coupled to the ends of the couplers, in which any one end of the copper tape may be in contact with any one of the pair of couplers.

A connection cable may be disposed with a first end coupled to a predetermined portion on an outer side of the connection pipe and a second end coupled to the pilot terminal, and a switch may be disposed on the connection cable at a predetermined position in a longitudinal direction of the connection cable.

The nozzle may include: a first nozzle having a pair of T-shaped grooves symmetrically formed around an outer side thereof with a predetermined gap therebetween; a second nozzle combined with the first nozzle such that a third cooling water channel is formed between an inner side thereof and the pair of T-shaped grooves, and having a plurality of holes formed in a circumferential direction at a predetermined positions in a height direction to connect the second cooling water channel and the third cooling water to each other; a third nozzle coupled to an end of the second nozzle to form a third air channel connected to the second air channel between an inner side thereof and an outer side of the second nozzle; and a nozzle cap inserted in the second nozzle such that the third nozzle is fixed to the end of the second nozzle and thread-fastened to the first threaded-portion on an inner side of a portion thereof.

### Advantageous Effects

According to the present invention having this configuration, it is possible to increase the speed of a high-temperature plasma flame using a simple structure, increase the lifespan of a nozzle and an electrode owing to improved cooling efficiency, and apply high voltage owing to improved cooling efficiency.

Further, it is possible to increase lifespan by minimizing damage to the nozzle due to a plasma flame.

### DESCRIPTION OF DRAWINGS

FIG. 1 is a cross-sectional view of a water-cooled plasma torch according to an embodiment of the present invention.

FIG. 2 is an exploded perspective view of the water-cooled plasma torch according to an embodiment of the present invention.

FIG. 3 is an exploded cross-sectional view of the water-cooled plasma torch according to an embodiment of the present invention.

FIG. 4 is a view showing flow of cooling water in the water-cooled plasma torch according to an embodiment of the present invention.

FIG. 5 is a view showing flow of air in the water-cooled plasma torch according to an embodiment of the present invention.

FIG. 6a is a view showing flow of gas in the water-cooled plasma torch according to an embodiment of the present invention.

FIG. 6b is a view showing flow of gas in a first gas channel and a second gas channel shown in FIG. 6a.

FIG. 7 is a partially enlarged cross-sectional of a connection cable shown in FIG. 1.

FIG. 8 shows cross-sectional views taken along lines I-I and II-II shown in FIG. 7.

### BEST MODE

Hereinafter, preferred embodiments of the present invention are described in detail with reference to the accompanying drawings. The thicknesses of lines and the sizes of components shown in the drawings may be exaggerated to make the following description clear.

Further, the terminologies described below are terminologies determined in consideration of the functions in the present invention and may be construed in different ways by the intention of users and operators or customs thereof. Therefore, the terminologies should be defined on the basis of the entire specification.

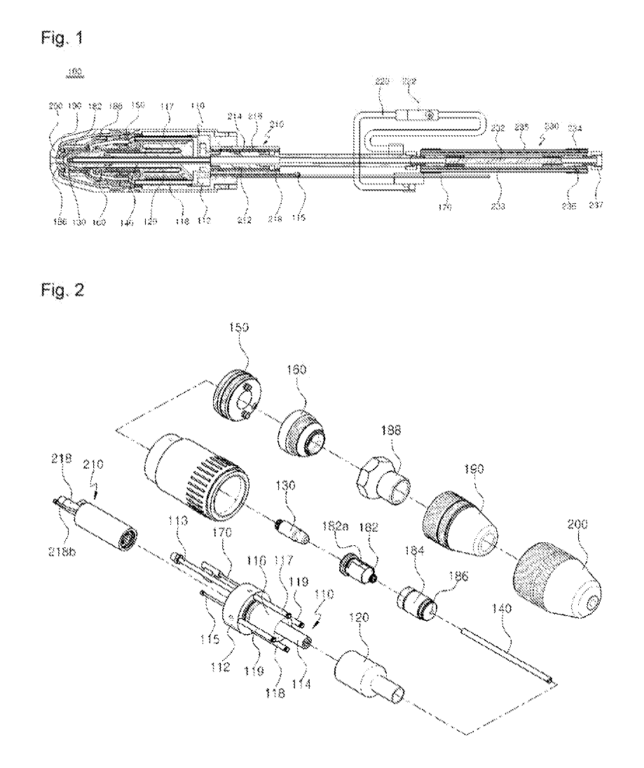

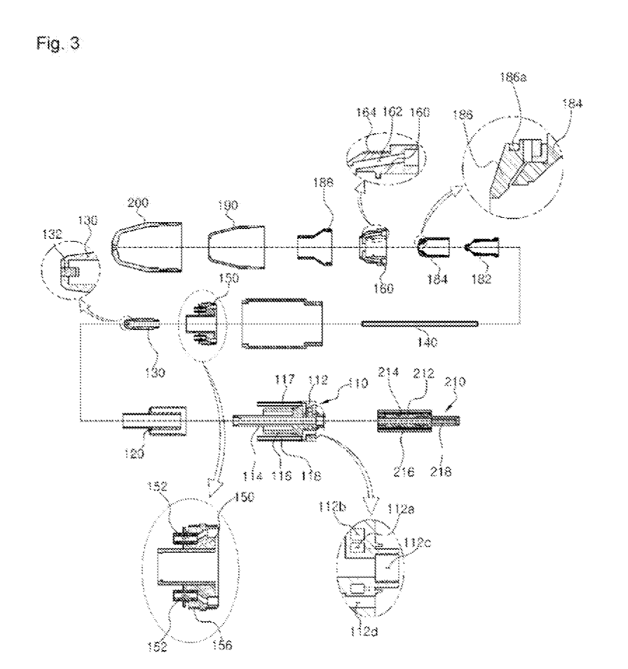

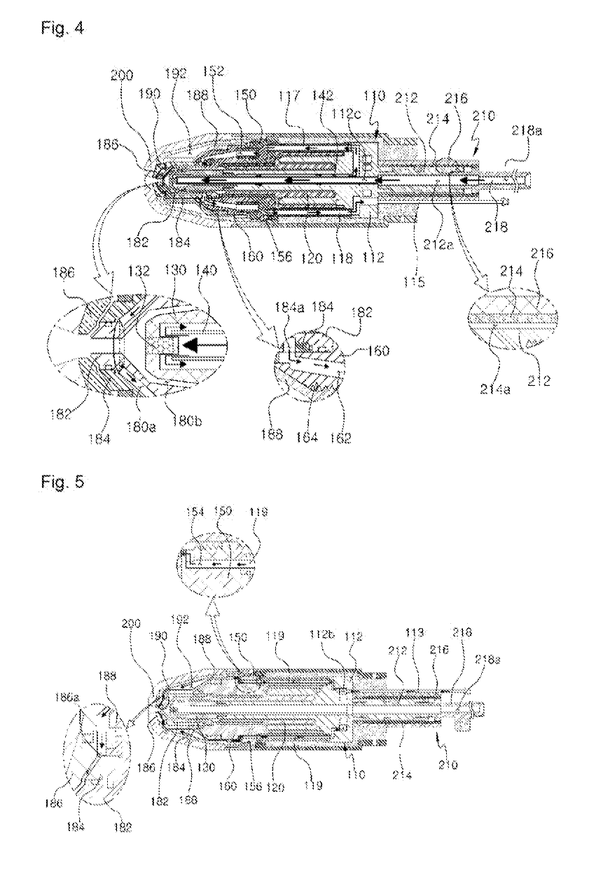

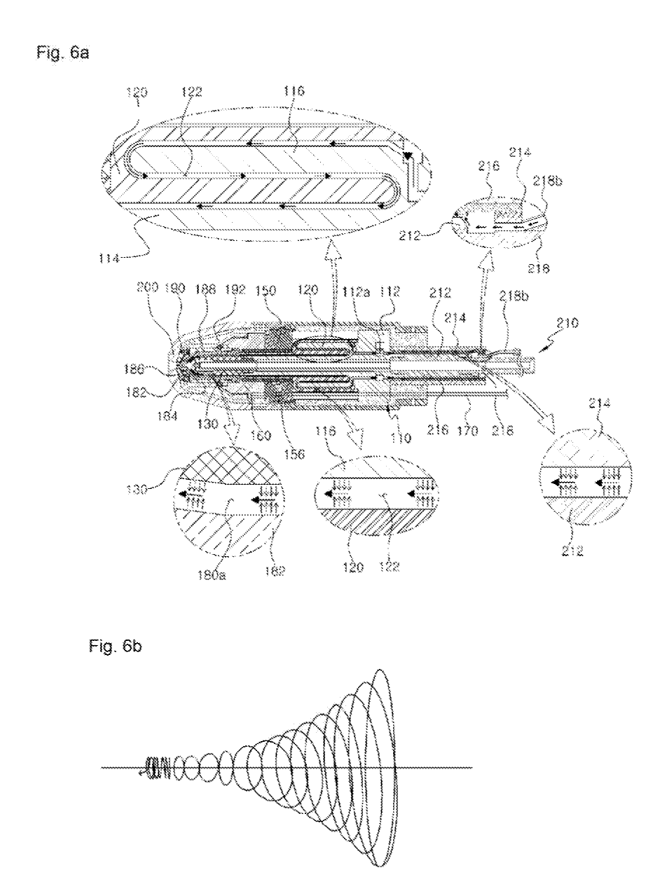

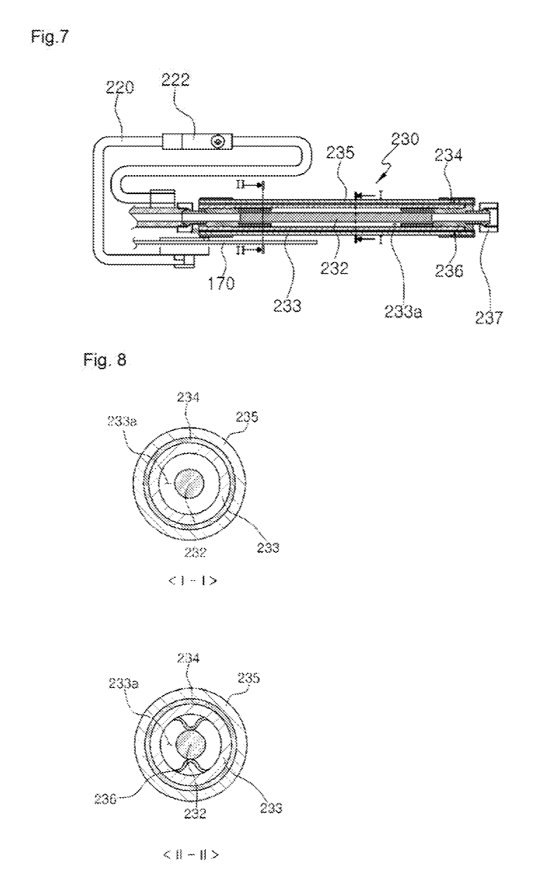

FIG. 1 is a cross-sectional view of a water-cooled plasma torch according to an embodiment of the present invention, FIG. 2 is an exploded perspective view of the water-cooled plasma torch according to an embodiment of the present invention, FIG. 3 is an exploded cross-sectional view of the water-cooled plasma torch according to an embodiment of the present invention, FIG. 4 is a view showing flow of cooling water in the water-cooled plasma torch according to an embodiment of the present invention, FIG. 5 is a view showing flow of air in the water-cooled plasma torch according to an embodiment of the present invention, FIG. 6a is a view showing flow of gas in the water-cooled plasma torch according to an embodiment of the present invention, FIG. 6b is a view showing flow of gas in a first gas channel and a second gas channel shown in FIG. 6a, FIG, 7 is a partially enlarged cross-sectional view of a connection cable shown in FIG. 1, and FIG. 8 shows cross-sectional views taken along lines I-I and II-II shown in FIG. 7.

Referring to FIGS. 1 to 8, a water-cooled plasma torch 100 according to an embodiment of the present invention includes a first body 110, a second body 120, an electrode 130, a cooling water tube 140, an insulator 150, a third body 160, a pilot terminal 170, a nozzle 180, an inner cap 190, and an outer cap 200.

The first body 110 includes a body part 112 having intake channels 112c and 112d for gas and air and intake and discharge channels 112c and 112d for cooling water therein, a first diameter part 114 protruding from the cooling water intake channel 112c at the center of the body part 112, and a second diameter part 116 protruding from the body part 112 at a predetermined distance from the first diameter part 114.

First and second cooling water circulation pipes 117 are symmetrically formed at a predetermined distance from each other circumferentially around the edge of the first body 110. Further, a pair of air discharge pipes 119 is formed between the first and second cooling water circulation pipes 117 and 118 and connected to the air intake channel 112b.

Further, a connection pipe assembly 210 is coupled to a second end of the first body 110. The connection pipe assembly 210 include: a first pipe 212 coupled to a second end of the first body 110 and having a cooling water supply channel 212a therein connected to the cooling water intake channel 112c; a second pipe 214 coupled to the first pipe 212 such that a main gas channel 214a connected to the gas intake channel 112a is formed outside the first pipe 212; an insulating pipe 216 fitted on the outer side of the second pipe 214; and a connection pipe 218 coupled to an end of the first pipe 212, having a central hole 218a formed though a center thereof and connected to the cooling water supply channel 212a, and having a gas supply pipe 218b connected to the main gas channel 214a at a predetermined position close to the edge.

Any one of both ends of the second pipe 214 may be in contact with a predetermined portion of the connection pipe 218 so that when a negative (−) current, which is a main current supplied to the connection pipe 218 through a copper wire of the connection cable 220 to be described blow, is supplied to the first pipe 212, a current is also supplied to the second pipe 214 in order for negative (−) currents flow in parallel in the same direction in the first pipe 212 and the second pipe 214.

That is, since negative (−) currents flow in parallel in the same direction in the first pipe 212 and the second pipe 214, separate magnetic fields are generated by the two current flowing in the first pipe 212 and the second pipe 214 and a force is generated toward the main gas channel 214a between the two magnetic fields, thereby increasing the speed of gas flowing through the main gas channel 214a.

The connection cable is disposed with a first end coupled to a predetermined portion on the outer side of the connection pipe 218 and a second end coupled to the pilot terminal 170 and a switch 222 may be disposed on the connection cable 220 at a predetermined position in the longitudinal direction of the connection cable 220. Accordingly, when a worker selectively supplies a negative (−) current that is the main current to the third body 160 through the pilot terminal 170 so that the current is supplied to the nozzle 103, the speed of the gas flowing through the second gas channel 180b formed between the inner side of the nozzle 180 and the outer side of the electrode 130 is increased.

That is, when a negative (−) current that is the main current is supplied to the third body 160 through the pilot terminal 170 and is then supplied to the nozzle 180, negative (−) currents flows in parallel in the same direction in the electrode 130 and the nozzle 180, so separate magnetic fields are generated by the two currents flowing in the electrode 130 and the nozzle 180 and a force is generated toward the second gas channel 180b between the magnetic field. Accordingly, the speed of the gas flowing through the second gas channel 180b is increased.

Further, a welding cable 230 is coupled to an end of the connection pipe assembly 210. The welding cable 230 includes: the copper wire 232 for supplying a negative (−) current to the connection pipe assembly 210; a braided hose 233 disposed around the outer side of the copper wire 232 with a predetermined gap therebetween to form a cooling water supply passage 233a; a copper tape 234 attached to the outer side of the braided hose 233; an outer cover hose 235 disposed on the outer side of the copper tape 234; a pair of couplers 236 partially inserted in both ends of the braided hose 233 with ends coupled to both ends of the copper wire 232, respectively; and sockets 237 coupled to the ends of the couplers 236.

The any one end of the copper tape 234 may be in contact with any one of the pair of couplers 236.

A copper wire may be braided on the outer side of the braided hose 233 instead of the copper tape 234.

The second body 120 is fitted on the outer side of the second diameter part 116 to form a first gas channel 122 connected to the gas intake channel 112a outside the first diameter part 114 and the second diameter part 116.

Gas supplied to the first gas channel 122 through the gas intake channel 112a is increased in speed while flowing through the first gas channel 122.

That is, since the negative (−) current that is the main current supplied to the first body 110 through the connection pipe assembly 210 flows in parallel in the same direction in the second body 120 too, separate magnetic fields are generated by the two currents flowing in the first body 110 and the second body 120 and a force is generated toward the first gas channel 122 between the two magnetic fields, so the speed of the gas flowing through the first gas channel 122 is increased.

The electrode 130 is detachably coupled to an end of the first diameter part 114 to prevent leakage of cooling water by surrounding the cooling water tube 140 and generate a plasma flame between a base material supplied with a positive (+) current and the electrode 130 by receiving the negative (−) currents supplied through the first body 110 and the second body 120, and has an electrode material 132 that is a hot emission material (for example, hafnium or zirconium).

The cooling water tube 140 is inserted in the center of the first body 110 to supply cooling water, which is supplied through the cooling water intake channel 112c, to the electrode 130.

A cooling water circulation channel 142 is formed between the outer side of the cooling water tube 140 inserted in the first body 110 and the outer sides of the first diameter part 114 and the electrode 130 such that the cooling water supplied to the electrode 130 through the cooling water intake channel 112c is supplied to the first cooling water circulation pipe 117.

The insulator 150 is inserted in an end of the second body 120 and has therein a first cooling water channel 152 connected to the first and second cooling water circulation pipes 117 and 118 and a first air channel 154 spaced from the first cooling water channel 152 and connected to the pair of air discharge pipes 119.

The third body 160 is coupled to an end of the insulator 150 and has a second cooling water channel 162 connected to the first cooling water channel 152 therein.

The pilot terminal 170, which supplies a pilot current to the nozzle 180 so that a plasma flame can be initially generated between the electrode 130 and the nozzle 180, is in contact with a predetermined portion of the third body 160 through the insulator 150.

The center of a portion of the nozzle 180 is inserted in an end of the third body 160, the inner side of the nozzle 180 is thread-fastened to a first threaded-portion formed on the outer side of the third body 160, and a third cooling water channel 180a connected to the second cooling water channel 162 is formed in the nozzle 180.

A second gas channel 180b is formed between the inner side of the nozzle 180 and the outer side of the electrode 130.

The nozzle 180 includes: a first nozzle 182 having a pair of T-shaped grooves 182a symmetrically formed around the outer side with a predetermined gap therebetween; a second nozzle 184 combined with the first nozzle 182 such that the third cooling water channel 180a is formed between the inner side thereof and the pair of T-shaped grooves 182a, and having a plurality of holes 184a formed in the circumferential direction at a predetermined positions in the height direction to connect the second cooling water channel 162 and the third cooling water 180a to each other; a third nozzle 186 coupled to an end of the second nozzle 184 to form a third air channel 186a connected to a second air channel 192 to be described below between the inner side thereof and the outer side of the second nozzle 184; and a nozzle cap 188 inserted in the second nozzle 184 such that the third nozzle 186 is fixed to the end of the second nozzle 184 and thread-fastened to the first threaded-portion 164 on the inner side of a portion thereof.

The inner cap 190 is thread-fastened to a second threaded-portion 156 formed on the outer side of the insulator 150 such that the nozzle 180 is inserted therein, and the second air channel 192 connected to the first air channel 154 is formed between the inner side of the inner cap and the outer side of the nozzle cap 188.

Further, the outer cap 200 made of an insulating material is fitted on the outer side of the inner cap 190.

Hereafter, use of the water-cooled plasma torch having the configuration described above is described.

FIG. 4 is a view showing flow of cooling water in the water-cooled plasma torch according to an embodiment of the present invention.

Referring to FIG. 4, cooling water that is supplied through the cooling water supply passage 233a of the welding cable 230 is supplied to the cooling water intake channel 112c of the first body 110 after flowing through the central hole 218a of the connection pipe assembly 210 and the cooling water supply channel 212a.

The cooling water supplied in the cooling water intake channel 112c is supplied to the electrode 130 through the cooling water tube 140, thereby cooling the electrode 130. Further, the cooling water, after cooling the electrode 130, flows to the first cooling water circulation pipe 117 through the cooling water circulation channel 142 formed between the outer side of the cooling water tube 140 and the inner sides of the first diameter part 114 and the electrode 130.

The cooling water flows in the first cooling water circulation pipe 117 and sequentially flows through the first cooling water channel 152 and the second cooling water channel 152 connected to each other inside the insulator 150 and the third body 160, is supplied to the third cooling water channel 180a formed in the nozzle 180, and cools the nozzle 180 while circulating in the nozzle 180a through the third cooling water channel 180a.

The cooling water supplied in the third cooling water channel 180a and cooling the nozzle 180 flows again through the first cooling water channel 152 and the second cooling water channel 152 connected to each other inside the insulator 150 and the third body 160, flows to the second cooling water circulation pipe 117, flows to the cooling water discharge channel 112d formed in the first body 10, and is then discharged to the cooling water discharge pipe 115 connected to the cooling water discharge channel 112d.

FIG. 5 is a view showing flow of air in the water-cooled plasma torch according to an embodiment of the present invention.

Referring to FIG. 5, when air is supplied to the air intake channel 112b through the air supply pipe 113 coupled to an end of the first body 110, the air supplied in the air intake channel 112b is supplied to the pair of air discharge pipes 119 circumferentially formed around the edge of the first body 110.

The air supplied to the pair of air discharge pipes 119 is supplied to the first air channel 154 formed in the insulator 150, flows through the second air channel 192 formed between the inner side of the inner cap 190 and the outer side of the nozzle 180, and is then discharged through the third air channel 186a formed between the second nozzle 184 and the third nozzle 186.

FIGS. 6a and 6b are views showing flow of gas in the water-cooled plasma torch according to an embodiment of the preset invention, in which FIG. 6a is a view showing flow of gas through the first gas channel and the second gas channel shown in FIG. 6a.

Referring to FIGS. 6a and 6b, gas is supplied to the main gas channel 214a through the gas supply pipe 218b of the connection pipe assembly 210. The gas supplied in the main gas channel 214a is supplied to the gas intake channel 112a formed in the first body 110 and then supplied to the first gas channel 122 formed in the first body 110 and the second body 120.

The gas supplied in the first gas channel 122 flows through the second gas channel 180b formed between the inner side of the nozzle 180 and the outer side of the electrode 130 and then flows into a space formed between an end of the electrode 130 and an end inside of the nozzle 180.

Thereafter, high-density gas is produced by the potential difference in the gap between the electrode 130 and the nozzle 180, which is called a pilot arc beam (PLASMA). The high-density gas arc beam produced in this way has low power because only a low current has been conducted through a resistor, but when the arc beam is connected to an object to be cut, a large current is shorted and electrode ions are instantaneously and continuously produced. Then, plasma gas is discharged outside toward the object to be cut through the outer cap 200.

Although preferred embodiments of the present invention were described above with reference to the accompanying drawings, it would be understood that the present invention may be changed and modified in various ways by those skilled in the art without departing from the spirit of the present invention described in the following claims.

### INDUSTRIAL APPLICABILITY

The present invention relates to a water-cooled plasma torch and, more particularly, it can be used for a water-cooled plasma torch that can increase the speed of a high-temperature plasma flame using a simple structure, can increase the lifespan of a nozzle and an electrode owing to improved cooling efficiency, and can apply high voltage owing to improved cooling efficiency.

1. A water-cooled plasma torch, comprising:
a first body including a body part having intake channels for gas and air and intake and discharge channels for cooling water therein, a first diameter part protruding from the cooling water intake channel at a center of the body part, and a second diameter part protruding from the body part at a predetermined distance from the first diameter part;
a second body coupled to a first end of the first body to form a first gas channel connected to the gas intake channel outside the first diameter part and the second diameter part;
an electrode coupled to an end of the first diameter part;
a cooling water tube inserted in a center of the first body to supply cooing water to the electrode;
an insulator inserted in an end of the second body, having a first cooling water channel therein, and having a first air channel spaced a predetermined distance from the first cooling water channel;
a third body coupled to an end of the insulator and having a second cooling water channel therein connected to the first cooling water channel;
a pilot terminal being in contact with a predetermined portion of the third body through the first body, the second body, and the insulator;
a nozzle having a center of a portion inserted in an end of the third body, having an inner side thread-fastened to a first threaded-portion formed on an outer side of the third body, and having a third cooling water channel connected to the second cooling water channel;
an inner cap thread-fastened to a second threaded-portion formed on an outer side of the insulator such that the nozzle is inserted therein, and having a second air channel connected to the first, air channel between an inner side thereof and an outer side of the nozzle; and
an outer cap fitted on an outer side of the inner cap.

2. The water-cooled plasma torch of claim 1, wherein a connection pipe assembly is coupled to a second end of the first body, and the connection pipe assembly includes: a first pipe coupled to a second end of the first body and having a cooling water supply channel therein connected to the cooling water intake channel; a second pipe coupled to the first pipe such that a main gas channel connected to the gas intake channel is formed outside the first pipe; an insulating pipe fitted on an outer side of the second pipe; and a connection pipe coupled to an end of the first pipe, having a central hole formed though a center thereof and connected to the cooling water supply channel, and having a gas supply pipe connected to the main gas channel at a predetermined position close to an edge thereof.

3. The water-cooled plasma torch of claim 2, wherein a welding cable is coupled to an end of the connection pipe assembly, and the welding cable includes: a copper wire; a braided hose disposed around an outer side of the copper wire with a predetermined gap therebetween to form a cooling water supply passage; a copper tape attached to an outer side of the braided hose; an outer cover hose disposed on an outer side of the copper tape; a pair of couplers partially inserted in both ends or the braided hose with ends coupled to both ends of the copper wire, respectively; and sockets coupled to the ends of the couplers,
wherein any one end of the copper tape is in contact with any one of the pair of couplers.

4. The water-cooled plasma torch of claim 2, wherein a connection cable is disposed with a first end coupled to a predetermined portion on an outer side of the connection pipe and a second end coupled to the pilot terminal, and a switch is disposed on the connection cable at a predetermined position in a longitudinal direction of the connection cable.

5. The water-cooled plasma torch of claim 1, wherein the nozzle includes: a first nozzle having a pair of T-shaped grooves symmetrically formed around an outer side thereof with a predetermined gap therebetween; a second nozzle combined with the first nozzle such that a third cooling water channel is formed between an inner side thereof and the pair of T-shaped grooves, and having a plurality of holes formed in a circumferential direction at a predetermined positions in a height direction to connect the second cooling water channel and the third cooling water to each other; a third nozzle coupled to an end of the second nozzle to form a third air channel connected to a second air channel between an inner side thereof and an outer side of the second nozzle; and a nozzle cap inserted in the second nozzle such that the third nozzle is fixed to the end of the second nozzle and thread-fastened to the first threaded-portion on an inner side of a portion thereof.
